(19) United States
(12) Patent Application Publication
(10) Pub. No.: US 2006/0225119 A1
(43) Pub. Date: Oct. 5, 2006

(54) VDSL splitter

(76) Inventors: Steven M. Wollmershauser, San Antonio, TX (US); Keith Joseph Allen, Austin, TX (US); William R. Hurst, San Antonio, TX (US); Ahmad C. Ansari, Cedar Park, TX (US); Vernon Daniel Reed, Austin, TX (US)

Correspondence Address: MATTHEW E. BURR;LAKE AUSTIN MARINA, 2219 WESTLAKE DR, STE 200, AUSTIN, TX, 78746, US

(21) Appl. No.: 11/095,939

(22) Filed: Mar. 31, 2005

(51) Int. Cl. H04N 7/173

(52) U.S. Cl. 725/121; 725/127

(57) ABSTRACT

A combination VDSL Splitter/Balun, Low pass filter converts a copper pair containing VDSL signals and PSTN service to be compatible with home coaxial and twisted pair wiring. A device of the invention performs the following functions: accepts VDSL and PSTN service in on a single twisted pair; provides front end voltage spike protection and test resistance circuit; and splits off the PSTN service to a connector compatible with a twisted copper pair; prevents signals above the voice spectrum from entering back through the twisted copper pair by filtering it to an RF level below the VDSL signal. The VDSL signal continues through the device and through a voltage blocker preventing the line and ring voltage from continuing. The impedance of the twisted pair is matched, through a balun, to a coaxial output on the device.

### FIELD OF THE INVENTION

The present invention relates to telecommunications equipment, and in particular to a VDSL splitter/converter to split VDSL and PSTN input from a twisted pair lead to a VDSL output and a PSTN output.

### BACKGROUND OF THE INVENTION

Very High Speed Digital Subscriber Line (VDSL) transmits data in the 13 Mbps-55 Mbps range over short distances, usually less than 5000 feet (1667 meters), of twisted pair copper wire. The shorter the distance, the faster is the connection rate. As the final length of cable into the home or office, VDSL connects to the premises Network Interface Device (NID), which connect to the Central Office's (CO) main fiber network backbone. The architecture allows VDSL users to access the maximum bandwidth available through normal phone lines.

VDSL is currently going through a standards debate, so it is not yet widely deployed. The VDSL alliance favors a line-coding scheme based on Discrete Multitone (DMT), a multi-carrier system that is more compatible with existing ADSL technology. The VDSL coalition favors a line-coding scheme based on Quadature Amplitude Modulation (QAM), a single-carrier system that is less expensive and consumes less power.

In contrast to VDSL, POTS (Plain Old Telephone System) uses differential signals carried by 100-ohm copper twisted pairs. Most signal generators, however, have single-ended 50-ohm inputs and outputs. A common way to interface these incompatible circuit types is to use a balun.

VDSL providers presently do not provide a balun that incorporates all of the features of the present invention. Accordingly, there is a need for a VDSL device that incorporates all the features of the present invention in a single device designed to fit into multiple types of network enclosures. The Invention provides an all-in-one device solution to simplify the installation of high bandwidth applications while reducing thought and effort for the installer.

### BRIEF DESCRIPTION OF THE DRAWINGS

The present invention is further described in the detailed description that follows, by reference to the noted drawing, by way of a non-limiting example of an embodiment of the present invention, in which reference numerals represent the parts throughout the view of the drawing, and in which:

FIG. 1 is a top view cross-section schematic drawing of a device of one exemplary embodiment of the present invention.

### DETAILED DESCRIPTION OF THE INVENTION

In view of the foregoing, the present invention, through one or more of its various aspects, embodiments and/or specific features or sub-components, is thus intended to bring out one or more of the advantages that will be evident from the description. The present invention is described with frequent reference to VDSL. It is understood, however, that VDSL is merely an example of a specific embodiment of the present invention, which is directed broadly to broadband telecommunications equipment within the scope of the invention. The terminology, examples, drawing and embodiments, therefore, are not intended to limit the scope of the invention.

The number of broadband subscribers worldwide passed the 150 million mark as of March 2005. This represents an increase of 51 million subscribers since the beginning of 2004. Experts forecast that the number of broadband subscribers will surpass 400 million during 2009. DSL continues to put distance between itself and cable as the most popular broadband technology.

A growing number of high-capacity broadband data transfer schemes are described by the generic acronym xDSL. VDSL is a specific example of an xDSL broadband solution. Like some other types of xDSL, VDSL is asymmetric. That is, usually more files are downloaded to the user than are uploaded to the server. The upstream rate for a 1,000-ft reach is typically 1.5 to 2.3 Mb/s.

By the reckoning of many, ISDN was the first xDSL service. Initially envisioned to carry simultaneous dial-up switched-circuit data and voice or double-rate data, ISDN at its best only offers 128 kb/s. Two 64-kb/s B channels can be bonded at extra cost.

Internet users demand a total interconnect flexibility not possible with ISDN. Internet data transfer is better suited to a packet-switched virtual network than to the fixed-circuit switched telephone network. The Internet is proving to be the killer application that some experts had earlier hoped would be high-speed video applications such as Video on Demand (VOD) and video conferencing.

VDSL facilitates VOD with up to 52-Mb/s downstream rates and a reach of about 1000 ft. The downstream rate drops with longer distances. As a consequence, VDSL is often part of FTTC installations or serves the immediate neighborhood of the CO. Either option offers much greater speed than typical Internet users experience.

Recently, lower-cost forms of forms of xDSL have appeared. Whole-scale replacement of the entire PSTN CO-to-user connection cannot be economically justified, so lower cost forms adapt to the existing subscriber copper loop wiring—the so-called last mile (actually, the last mile can be two or three miles).

Standard loop loss tests specify 12,000-ft and 18,000-ft distances with or without specific impairments such as bridged taps and splices. Typically, the feeder and distribution cables from the CO are not cut when a connection is made to a local subscriber. Instead, the subscriber's drop wire is bridged to an unused pair in the distribution cable within a neighborhood that, in turn, is bridged to an unused pair in the main feeder cable.

But when service to the subscriber is discontinued, the bridged taps are not necessarily removed. The circuit simply is disconnected at the subscriber end. As a result, stubs of various lengths are formed, which wreak havoc with the response of the overall loop pair to the high frequencies used by xDSL, although presenting few problems for the POTS. Most forms of xDSL, therefore, have to work with some bridged taps.

The existing copper loop maintains the integrity of the existing telephone service for both data and POTS, although additional hardware may be needed for xDSL. For example, T1.413 ADSL requires a splitter at each end of the loop to separate/combine POTS and digital data signals. Also, echo cancellation may be required because some of the lower-numbered bins can be used for both upstream and downstream data.

G.lite is a splitterless version of the T1.413 DMT standard that uses only the lowest-frequency 128 bins of the 256 ADSL bins, reducing the transmitted frequency range. Its 1.5-Mb/s downstream speed is far below the highest ADSL rate, but G.lite tends to be less susceptible to line impairments due to its lower speed.

Splitterless xDSL implementations add the HP filter to the modem circuit board and they eliminate the LP filter. Consequently, the local POTS hardware receives the full-strength modem signal. The modem power is reduced to reduce the effect of the modem HF signals on POTS. The modem upstream data rate is also reduced, but not necessarily the downstream rate.

POTS uses differential signals carried by 100-ohm copper twisted pairs. Most signal generators, spectrum analyzers and oscilloscopes have single-ended 50-ohm inputs and outputs. A good way to interface incompatible circuit types is to use a balun.

A balun is a device designed to convert between balanced and unbalanced electrical signals, such as between coaxial cable and twin-lead. The conversion is typically performed by a small isolation transformer. The earth ground or chassis ground is left floating or unconnected on the balanced side. The transformer also performs impedance matching at the same time.

A balun can convert impedance, making it easy, for example, to drive the POTS 600-ohm system impedance from a 50-ohm output impedance generator. A separate balun is required to drive the system impedance of the copper loop in the higher-frequency band used by xDSL. For example, ADSL has a 100-ohm system impedance. For a dedicated TIMS, the source and receive ports already are differential and present the correct impedance. The list of tests includes the following:
Attenuation
NEXT and FEXT crosstalk
Longitudinal conversion loss
Characteristic impedance
Spectrum

Common uses of baluns include:

(1) In television, amateur radio, and other antenna installations and connections, to convert between ribbon cable (balanced) and coaxial cable (unbalanced) or to directly feed a balanced antenna with (unbalanced) coax.

(2) In audio applications, to convert between high impedance unbalanced and low impedance balanced lines.

(3) In power line communications, baluns are used in coupling signals onto a power line.

Signal attenuation varies with distance. Increasing the reach from 12,000 ft to 18,000 ft represents an additional 40-dB loss at the highest ADSL frequencies. The corresponding additional loss for G.lite operating up to 400 kHz is only about 20 dB. xDSL modems deal with signals having a very large, 120 dB, dynamic range.

Because the loop exhibits such large attenuation, a modem must have high gain at high frequencies. Noise and crosstalk may be limiting factors if they are similar in amplitude to the desired signal. NEXT testing determines the effect of other nearby copper pairs carrying large signals.

When using two baluns to simulate a NEXT condition, they should be shielded from each other by a metal plate. Otherwise, the coupling between the baluns could be larger than that of the two copper pairs.

The present invention provides a combination VDSL Splitter/Balun, Low pass filter used to convert a copper pair containing VDSL signals and PSTN service to be compatible with home coaxial and twisted pair wiring. A device of the invention performs the following functions:
1. Accepts VDSL and PSTN service in on a single twisted pair.
2. Front end Voltage spike protection and test resistance circuit.
3. Splits off the PSTN service to a connector compatible with a twisted copper pair.
4. Prevents signals above the voice spectrum from entering back through the twisted copper pair by filtering it to an RF level below the VDSL signal.
5. the VDSL signal continues through the device and through a voltage blocker preventing the line and ring voltage from continuing.
6. The 100-ohm impedance of the twisted pair is matched, through a Balun, to a 75-ohm coaxial output on the device.
7. The filter fits into current Telco® NID enclosures by, for example, clipping in, as with the other components in the NID.

The device is suitable for any FTTN application requiring high bandwidth. Embodiments of the invention comply with DSL forum requirements and offer advantages to ILECs, or any company, deploying xDSL to deliver an IP Video solution.

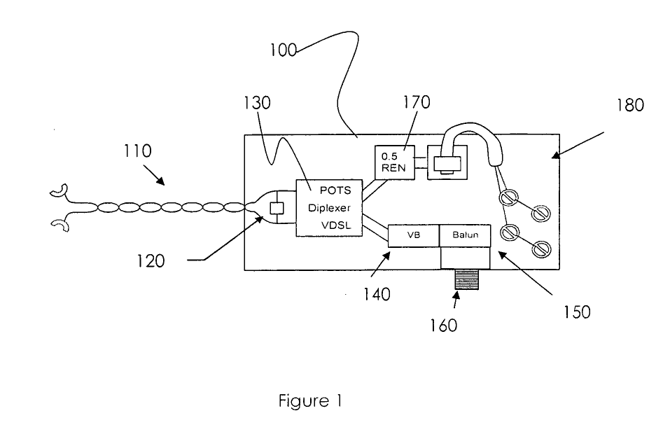

FIG. 1 is a top view cross-section schematic drawing of a device of one exemplary embodiment of the present invention. Unit 100 provides input connector 110 to connect, for example, VDSL and PSTN input over a single twisted pair copper wire. Spike protector 120 between input connector 110 and diplexer 130 is provided in specific embodiments and omitted in alternative embodiments. Diplexer 130 discriminates and splits POTS input from VDSL input and directs each to its output port, 180, 160, respectively.

Voltage blocker 140, connected to diplexer 130, inhibits DC and ring voltage from reaching VDSL output connector 160. Balun 150 between voltage blocker 140 and output 160 matches the 110-ohm impedance from twisted pair input 110 to, for example, a 75-ohm coaxial output 160 of unit 100. PSTN input is directed by diplexer 130 through optional 0.5 REN resistor 170 to PSTN output 180 connected to, for example, a home telephone.

Table 1 suggests exemplary specifications useful in connection with understanding FIG. 1.

TABLE 1

| Input: | Outputs: |
|---|---|
| Twisted pair: Balanced | POTS: |
| 110 Ohm, color-coded | Color-coded screw terminals for |
| (red and green) twisted | 110 Ohm twisted pair wire |
| pair leads with terminal lugs. | 0.5 REN load for remote |
| Frequency: DC-20 MHz | metallic testing |
| Optional: spike protector | Frequency: DC-4 KHz |
| | Insertion Loss: 1 dB max to 4 KHz, |
| | >25 KHz: 60 dB min |
| | DC passing .5 amp |
| | CMR: Components to handle ringing |
| | voltages |
| | VDSL: |
| | 75 Ohm un-balanced right-angle |
| | “F” connector |
| | Frequency: 25 KHz-20 MHz |
| | Insertion loss: DC: block |
| | 25 KHz-20 MHz: 1 dB max |
| | 54 MHz: 30 dB min |
| | Note: Recommend attenuated harmonics |
| | of the ringing voltage and narrow spikes. |

Physical Packaging: Recommend packaging adapted for mounting
the unit as a line module inside the various NIDS used by the service
provider. Recommend that packaging allow for connecting a coaxial
cable to the F connector and running the cable out the bottom of the NID.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

We claim:

1. An electrical splitter that splits upstream input to two or more downstream outputs, the splitter comprising:
a VDSL and PSTN input connector;
a diplexer downstream of the input that discriminates a VDSL signal input from a PSTN signal input and directs each signal to a respective output;
a VDSL output port;
a voltage blocker between the diplexer and the VDSL output, wherein the blocker inhibits DC and ring voltage from reaching the VDSL output;
a balun between the voltage blocker and the VDSL output to match input impedance to output impedance; and
a PSTN output port downstream of the diplexer.

2. The splitter of claim 1, wherein the input connector connects to a single twisted pair conductor carrying VDSL and PSTN signals.

3. The splitter of claim 1, wherein PSTN comprises POTS.

4. The splitter of claim 1, wherein the PSTN output port connects to a telephone.

5. The splitter of claim 1, wherein the VDSL output port connects to coax.

6. The splitter of claim 1, further comprising a voltage spike protector upstream of the diplexer to protect the splitter from voltage spikes.

7. The splitter of claim 1, wherein the splitter splits off the PSTN service to an output connector compatible with a twisted copper pair.

8. The splitter of claim 1, wherein signals above the voice spectrum are filtered to an RF level below the VDSL signal to inhibit voice signal feedback from a PSTN twisted pair to the VDSL output.

9. The splitter of claim 1, wherein the balun matches 110-ohm twisted pair input impedance to 75-ohm coaxial output impedance.

10. The splitter of claim 1, wherein the splitter fits a Telco® NID enclosure.

11. An electrical splitter that fits a Telco® NID enclosure and splits twisted pair 110-ohm impedance VDSL and PSTN input to a PSTN output and a 75-ohm impedance VDSL output, the splitter comprising:
A twisted pair input connector, wherein the twisted pair carries VDSL and PSTN signals;
a diplexer downstream of the input that discriminates a VDSL signal input from a PSTN signal input and directs each signal to a respective output;
a VDSL output port;
a voltage blocker between the diplexer and the VDSL output, wherein the blocker inhibits DC and ring voltage from reaching the VDSL output;
a balun between the voltage blocker and the VDSL output to match the input impedance to the output impedance; and
a PSTN output port downstream of the diplexer.
